(19) United States
(12) Patent Application Publication
(10) Pub. No.: US 2009/0252303 A1
(43) Pub. Date: Oct. 8, 2009

(54) TELEPHONE APPARATUS AND METHOD OF MAKING AND RECEIVING CALLS WITH URGENCY TAGS

(76) Inventor: Sanjiv Agarwal, Kolkata (Calcutta) (IN)

Correspondence Address: SANJIV AGARWAL, 25C/1 BELVEDERE ROAD , CALCUTTA 700027, INDIA, CALCUTTA, 700027, IN

(21) Appl. No.: 12/303,115

(22) PCT Filed: May 28, 2007
(86) PCT No.: PCT/IN2007/000209

§ 371 Date: Dec. 2, 2008

(30) Foreign Application Priority Data
Jun. 6, 2006 (IN) 548/KOL/2006

(51) Int. Cl. H04M 3/42; H04M 11/04; H04M 15/00

(52) U.S. Cl. 379/37; 379/208.01; 379/114.03

(57) ABSTRACT

Based on the urgency, the caller ads a priority tag number while making telephone calls. The called party receives the calls with different alarm features based on the urgency of the call. The called party can set profiles rules so that calls with a lower urgency may be blocked if inconvenient. The profile rules may be altered autonomously in various circumstances. In addition a new configuration of telephone instruments is disclosed, having special keys and different alarm features, for enabling prioritization in transmission and reception of calls.

### TECHNICAL FIELD

The invention relates to telecommunication instruments and signaling techniques. In particular it relates to mobile telephony in computerized telecom networks.

### BACKGROUND OF THE INVENTION

Rapid advancement of telecommunication technology worldwide has created a global village of unrestricted access to anyone anytime anywhere in the world. This huge advance has created new opportunities as well as new problems. The problem is increased also due to rapid globalization of commerce resulting in huge proliferation of telephone calls one would receive.

Mobile cell-phones carried with the person have enhanced the connectivity substantially at the same time creating new problems of intrusiveness in privacy of the user and the audiences in the surroundings. The usefulness of cell-phones as a critical aid for better connectivity in urgent situations (some of which can be life threatening) is hampered by the inconvenience of unwarranted and unwanted calls and SMS messages. Caller Line Identity (CLI) programs such as Automatic Number Identification (ANI) or Calling Number Delivery (CND) or Caller ID mitigate the inconvenience to some extent, by displaying the number of the calling party to the receiving party. This also has major limitation because it leaves the task of evaluating the importance and/or urgency of the caller on the recipient, only on the basis of origin of the call. This problem is increased if the called party is roaming outside its local subscription area, leading to not only inconvenience but also higher charges for receiving low priority calls.

The existing prior art in the field concentrates on filtering calls based on caller identification protocols selected by the called party, by way of the called party defining rules about how calls from a particular telephone number will be processed i.e. whether it will be completed or not immediately. A major limitation in these remain that all calls from the same phone numbers are handled in the same way indefinitely, till the recipient changes the rules selected earlier. But the same or a different caller in different circumstances may use the same phone line. As a result, a call from the same caller in a different circumstance or a different caller using the same phone may be undesirably prioritized or filtered. Therefore, if the called party has selected only certain phone numbers for allowing completion based on past experience, a major disadvantage may be that an unimportant call from the same number may be allowed whereas an important and/or urgent call from a new number may be disallowed, causing inconvenience and embarrassment to the caller and the called party.

For example, European patent number EP0837611 and related U.S. Pat. No. 6,005,870 of AT&T Corp. discloses a method for providing called party control in a telecom network. It has the limitations mentioned above, as the treatment table and emergency codes provided therein are identity dependent i.e. fixed as per caller identity and all calls from a caller are treated in the same way according to the said treatment table. For example, a call from the called party's home telephone number, identified by a PIN as the called party's spouse and further identified by a predetermined emergency code have the highest priority level call treatment. As a result, a causal call from the spouse e.g. to check about eating out will be handled at a high priority, whereas an unknown caller such as an unidentified neighbor calling in emergency e.g. for reporting a fire in one's home being handled as junk. If the said spouse is calling in distress from a different phone, say a public phone, there is no way she can mark the call as emergency call.

U.S. Pat. No. 6,385,310 discloses a method of marking calls at the receiving switch, based on predetermined logic like all calls identified from ‘out-only’ call centers, who might voluntarily opt for being identified as unsolicited. This has limitations in that an undesirable and or unimportant call may be made using other unidentified phone lines. Moreover, an identified phone line might not be used effectively for making an urgent and important call to a recipient who has barred calls from such lines.

There are other techniques in the prior art, which focuses on routing the call through various logics whereby an incoming call is processed through various stages and time loops, to eventually allow or disallow completion of call. For example U.S. Pat. No. 6,621,896 discloses a self-screening mode that if switched on takes the caller through a three stage automated dialogue to identify the urgency of the call. The most important limitations in these are that an important and/or urgent call has to go through the same routine. As a result, it may waste time of an important and/or urgent caller, which may be undesirable. For example, in an emergency or panic situation e.g. when the call is from or to a person trapped in fire, it may not only hinder the completion of the call due to its complications but also delay the call and thereby worsen the situation. The longer time taken in this technique may also result in many more disadvantages e.g. longer engagement of resources, resulting congestion and increased costs esp. if the call is charged as per its duration. Moreover, a very important caller may find the rigmarole unacceptable and refuse to complete the call, embarrassing both parties.

In a published United States Patent Application 20040177122 Appelman, Barry et al have disclosed Source audio identifiers for digital communications, which is limited to and directed at identifying the source of the communication by playing an audio signal associated with it.

Jamming or blocking techniques of disabling the use of mobile phones in certain locations and facilities have an important limitation in that urgent and emergency calls may also be restricted.

The present invention discloses a unique method of calling party adding different urgency tag (TAG) numbers depending on the priority or the nature of calls. The calls are processed as per their urgency tag numbers, in response to profile rules that may be set by the called party. The profile rules may be set autonomously in certain circumstances. One of the unique features is that the caller has the opportunity to provide a priority marker on each call based on his or her urgency perception of that call, and the called party control is dynamic to each call. As a result, call from a known or unknown caller from a known or an unknown number can be dynamically prioritized and processed, as per urgency indicators provided by the caller, as per the circumstances of each call. Accordingly, in one aspect of the invention differs from prior art in that it provides the calling party an effective control, apart from the called party also having an equally effective control, in an uncomplicated and timesaving method for dynamically prioritizing each call.

### OBJECTS OF THE INVENTION

The object of the invention is to present a more practical, less complicated and more useful technique of prioritizing calls by the calling party so that the calling party can add an urgency indicator on each call instantly and receiving party get the indicator of urgency perception of the caller instantly, even before picking the call.

Another object is to filter the calls based on urgency irrespective of the number from which the call is made.

The object of the invention includes reducing the cost of receiving calls by mobile telephone subscribers, by restricting the type of calls that can be made while they are roaming out of their subscribed geographical area.

The object also includes finding an improved method for using mobile phones in situations where the privacy and utility needs are required to be balanced, e.g. while in a public transport.

The invention also helps telecom operators in offering new and improved services to their subscribers thereby creating more consumer satisfaction and increased revenues.

The telecom infrastructure is optimized in its use by prioritizing calls and charging accordingly, by applying the features disclosed in the present invention.

### SUMMARY OF THE INVENTION

The invention described here disclosed a new technology for making and receiving telephone calls suitably tagged on the basis of their urgency. This is achieved by programming techniques applied to the existing telecom networks and preferably telephone instruments as well.

A telephone instrument may have specific keys with marks such as ‘Ordinary’ or ‘Urgent’. After dialing a number, one of these keys are pressed, upon which a specific urgency code number e.g. 1 or 2 is added to the number dialed. This can be achieved by providing such keys parallel to the number to be dialed, which means that when one of such keys are pressed e.g. the one marked with Urgent, the corresponding number e.g. 2 is dialed. Programming capability in the operating system of a modern telecom instrument can be effectively utilized whereby on pressing a particular key, the corresponding urgency number is added, by applying program logic. Alternatively, existing instruments may be used by pressing the corresponding number keys after dialing the number, e.g. ordinary or urgent may be selected by pushing buttons 1 or 2, after entering the destination number.

The receiver instrument is able to distinguish the call as such, by emitting a different color of light, ringing a different tone, vibrating and/or displaying a message e.g. URGENT CALL along with or without notification of the CLI.

The receiving party can define rules like receive ‘urgent calls only’ e.g. when in a meeting or in a cinema hall. In this case all ordinary calls are prompted to a voice mailbox. Pressing specified button can restore default position of allowing all calls. Alternatively, the cell phone can be programmed to automatically define rules as mentioned above, for example if the user selects Profiles like ‘meeting’, ‘silent’ etc. from the usual menu.

There is a possibility of providing more levels of urgency e.g. by way of adding digit for example 4 for Commercial calls, which would be received with yet another variant of alert signal like ‘no-beep or ring’. To signify highest level of urgency there can be a specified number such as 9, when added will be processed as ‘Emergency call’, which may be received with emphasized signals like ‘red light emission with hooter ring-tone and vibration’, for example. All calls without any urgency tag numbers added may be processed conventionally or as if with a particular urgency tag e.g. Ordinary calls as explained above. Altering the signals at the receiving end as per the tag put by caller can be achieved by programming at the exchange level, working in conjunction with telephone instruments, utilizing its software and hardware resources. There can be further enhancements like routing the Emergency and/or Urgent calls through a different priority highway or any other route that may be available, including a long distance route, if the usual route is busy. Such calls can be charged at a higher rate. Other features like ‘call-waiting’ signals can also be differentiated, for example an emphasized call waiting signal in case of an Urgent call and ‘barge-in’ in case of an Emergency call.

In one embodiment, if the called party is mobile telephone user and is roaming outside his local subscription area, the calls with low priority tags may be barred, caller informed and diverted to voice mail service.

Telephone instruments may be programmed with embedded computer logic to achieve different dialing modes, e.g. by pushing a specific number key after dialing a telephone number, the number is added as a tag to the number dialed or by pressing special keys provided, same effect is achieved, viz. to and notify the urgency tag numbers to the entities in a modern telecom network. Existing digital handset may be reprogrammed to set rules for transmission and reception of calls so tagged.

### BRIEF DESCRIPTION OF DRAWINGS

FIG. 1 shows an example of prior art embodiment and best example embodiments of the present invention applied to a mobile wireless telephone receiver

FIG. 2 shows further example of embodiments of the present invention at the receiver's end, for setting rules to bar or debar receiving of calls on the basis of urgency tag.

FIG. 3 shows simple flowcharts of prior art calling process vis-à-vis the present invention

FIG. 3A shows a flowchart of a best embodiment of the present invention, when a mobile telephone user is Roaming out of his subscribed geographical area.

FIGS. 4 and 5 show simplified flowcharts of unsuccessful call situations as per the present invention

### DETAILED DESCRIPTION WITH REFERENCE TO THE DRAWINGS

The interrelation and working of various entities in a modern telecom network is well known and a detailed description of the same can be very lengthy and is not necessary to describe for enabling the present invention. A person skilled in the art can readily apply the disclosures below to enable the present invention to work seamlessly in any modern telecommunication network such as so called Advanced Intelligent Network or Intelligent Networks.

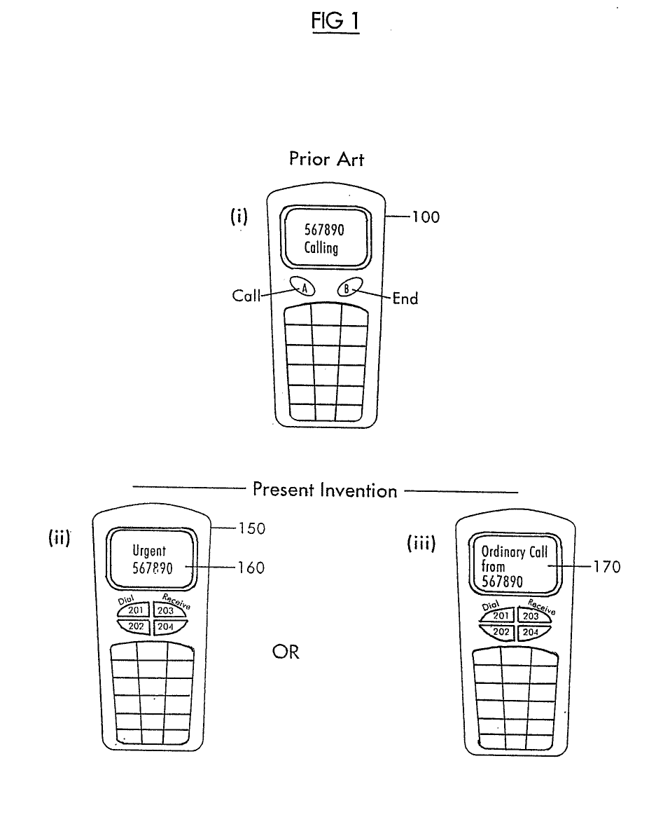

FIG. 1 shows a prior art example mobile hand-phone instrument (100), which is operable by first dialing a number such as 567890 and then pressing the button A to activate the phone to connect to wireless tower connected to the telecom network.

The same device is known to receive calls from any other telephone connected in the network. On receiving such calls, the handset is known to display the number of the calling party if the caller line identification (CLI) is enabled. The mobile handset is also known to usually emit a light, ring tone and/or vibration, on receiving a call, as optionally set by the user or the default factory setting. Various menu-driven options are generally available to activate or deactivate some of these incoming call alarms. For example if Silent mode is selected, the light and vibrator is activated but the ring tone is deactivated.

In the present invention, it is contemplated that the example receiver Instrument (150) will be able to identify a call on the basis of different urgency tag numbers put by the calling party, and will activate different alarm feature accordingly, including alpha-numeric graphic display, ring-tone, emission of light and vibration. In example instrument 150, the call is identified as Urgent in the alphanumeric graphic at 160 and a special light, ring-tone and/or vibration signal is emitted, in contrast with an ordinary call displayed as such at 170, wherein an ordinary light, ring-tone and/or vibration is signaled. In the simplest embodiment, such an instrument such as the one shown at 100 has the capability to display in the CLI panel the caller's number along with the urgency tag number supplied by the caller e.g. 567801 or 567802 signifying an ordinary and an urgent call respectively, as per the above. Other features like ‘call-waiting’ signals can also be differentiated, for example an emphasized call waiting signal in case of an Urgent call and ‘barge-in’ in case of an Emergency call.

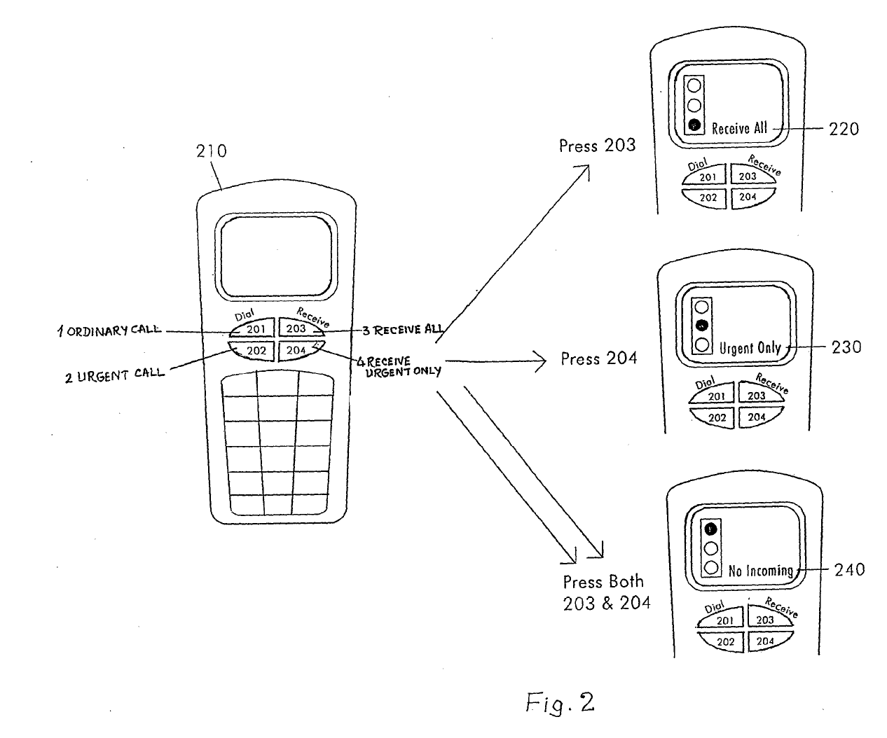

The calling party has the options to add a tag number to the call as shown in FIG. 2 for example. At 210 is shown an example handset having keys 201 and 202 to add tag number e.g. 1 for Ordinary or 2 for Urgent. This can be achieved connecting the keys 201 and 202 parallel to 1 and 2 respectively, in a way that when one of such keys is pressed e.g. 202, the corresponding number e.g. 2 is dialed. Alternatively, programming capability in the operating system of a modern telecom instrument can be effectively utilized whereby on pressing 201 or 202, the corresponding urgency number 1 or 2 respectively is added and the dialing process is started, by applying program logic. Alternatively, the urgency tag can be added by pressing the corresponding number key e.g. 1 for ordinary or 2 for urgent call, just after dialing the called party number on an existing handset such as that shown at 100. In a preferred embodiment, if the caller adds no tag number, the tag number corresponding to ordinary calls e.g. 1 is added by the switch automatically, in response to a programmed feature in an associated intelligent peripheral. There may be point in the network up to the called party switch can also have the ability to add the ordinary tag automatically on a call notified without any tag e.g. to a call dialed from an area where the features of this invention have not been implemented.

An Advanced Intelligent Network (AIN) or Intelligent Network (IN) is a service independent telephone network. Its capabilities can be effectively utilized to implement the working of this invention by applying computer programming. For example, the Service Switching Point (SSP) in an AIN or IN has programmed capability as per a call model, to receive notification of a call tagged with a urgency tag number and process it in conjunction with an Intelligent Peripheral (IP) and/or a Service Control Point (SCP). In one embodiment, the tag number can be simply forwarded in the entire network as an information digit. For example, the first switch receiving the calling party call with an urgency tag number can mark the call by way of a forward call indicator IAM message or with information digits used in multi-frequency signaling, and the same is relayed throughout the network.

The call model in an AIN or IN is a generic representation of SSP call-processing activities required to establish, maintain, and clear a basic call. The call model consists of point in calls (PICs), detection points (DPs), and triggers. PICs represent the normal switching system activities or states that a call goes through from origination to termination. The PIC can include a TAG number, which the SSP can recognize as a trigger detection point (TDP). When an active trigger is detected, normal switching system call processing is suspended until the SSP complete communications with SCP. Essentially, when the SSP recognizes that a call has an associated AIN trigger, such as a TAG number as per the present invention, the SSP suspends the call processing while querying the SCP for call routing instructions. Once the SCP provides the instruction as per a stored program e.g. to route the call with emergency tag 9 through a special route, the SSP continues the call model flow until completion of the call.

SSP is co-located with the telephone exchange itself, and acts as the trigger point for further services to be invoked during a call, which may include recognizing a TAG number and processing it. The SSP implements the Basic Call State Machine (BCSM), which is a Finite State Machine that represents an abstract view of a call from beginning to end, which can be programmed to include an urgency TAG as per this invention. As each state is traversed, the exchange encounters Trigger Detection Points or Trigger Check Points (TDP or TCP) at which the SSP may invoke a query to SCP, for further instructions on how to proceed. This query is usually called a trigger. Trigger criteria are defined by the operator and might include the subscriber calling number, the dialed number and the urgency TAG number. For example, the TAG number received at SSP is detected at a TCP and triggers a query to the SCP. The SCP program checks whether the TAG supplied is valid and if yes, is tag a high urgency tag e.g. 2 or 9 in which case the call is routed according to a preset logic e.g. through a route reserved for calls with such TAGs. The SCP contains service logic which implements the behavior desired by the operator, which may be programmed to implement the features of the present invention. In another example, even if no tag has been added or in case of calls originating from specified numbers, the SSP can interact with the SCP to provide a predetermined tag e.g. 1 if no tag has been attached to a call originating from a general telephone number or 4 in case of the call is from a telemarketing subscriber. The SCP can also be programmed to send an entry in the billing processors, as per service features and pricing. During service logic processing, additional data required to process the call is obtained from the SDF. Service Data Function (SDF) or Service Data Point (SDP)—a database that contains additional subscriber data, or other data required for processing a call, which can include a permanent urgency TAG to be applied on calls originating from a caller number, e.g. TAG 4 on a call originating from a telemarketing subscriber. The SDF may be a separate platform, or is sometimes co-located with the SCP. At the called party end, the SCP can also have program capability to register urgency profile settings of a called party at any given point of time, and handle calls with each urgency tag number accordingly, if the call treatment is to be at the exchange level as per this invention. For example, the SCP may block call with an ordinary urgency TAG 1 and complete call with an urgent urgency TAG 9, if the called party has registered a busy privacy profile as per this invention. The SCP at called party can also have the ability to cause variation in alarm features of called party phone, as per various TAG numbers, as per these disclosures. The called party phone can also have programmed logic embedded in it, to work in conjunction with the signals received from the called party switch, in response to various TAGs. The logic on the SCP and on the operating system embedded in a modern phone is created using various computer languages like C, C++, Java or a proprietary graphical language, by a skilled person.

Intelligent Peripheral (IP) is a node in an AIN, which can connect to both the SSP and the SCP to deliver additional special resources into the cell. The interface between the SSP and the IP is an integrated services digital network (ISDN), primary rate interface (PRI), and/or basic rate interface (BRI). IP provides resources such as customized and concatenated voice announcements, voice recognition, and dual-tone multi-frequencies (DTMF) digit collection. The IP contains a switching matrix to connect users to these resources. The matrix can contain entries for various call TAGs received as the DTMF digits suffixed with the called numbers and logic for further treatment. In addition, the IP supports flexible information interactions between an end user and the network. For example, the IP can prompt the user to confirm or to add a TAG. The SSP and IP, both have the ability to play announcement and collect digits. In one embodiment, the SSP in conjunction with IP can have the entire capability of processing a call as per this invention, e.g. just flagging the call with the TAG number and forwarding in the network. In another embodiment, calls with some tags e.g. those with low urgency tags 1, 4 are handled by the SSP with IP and calls with high urgency TAG e.g. 2 or 9 trigger a query to the SCP for handling logic. Basically, routing the call is an SSP function, and number translation is an SCP capability. By arranging these capabilities or basic building blocks in various combinations, services such as the present invention can be created, through computer programming as per the present disclosures, resulting in a surprising technical effect on the operation or the telecommunications equipments, beyond their known functions.

In an embodiment, the urgency TAG numbers are simply transported in the entire network and notified to the called party instrument which has the in-built ability to receive it and announce it utilizing its hardware and software in a way to allow the called party to perceive the urgency of the call. For example, the TAG number is simply displayed with the AIN or is translated to a text like ‘urgent call’ or ordinary call’, by applying programming. In another example embodiment, the TAG is transported up to the called party switch, which in conjunction with its SCP is able to activate different ring cadences in respect of different urgency TAG numbers. A phone rings when a special ringing signal is sent to it. For example, for a regular telephone the ringing signal is a 90 volt, 20 hertz, AC wave generated by the switch to which the telephone is connected. For mobile phones, the ringing signal is a specific, radio-frequency signal. The invention can be implemented by varying these signals for producing a predetermined unique ring tone as per the hardware or software resources in a called party telephone apparatus, in response to each urgency tag, so that the called party is able to perceive the urgency of the call. However, as per the previous example, if TAGs are relayed to cellphone as a number, the embedded operating system program in the cellphone can have the ability to read the said TAG number and activate a specific ring tone on a call being received with a tag number.

The grading and tagging of call based on urgency can be at multiple levels. For example, a third level ‘Emergency’ call may be introduced which can be triggered either by a separate Panic key provided in the handset or for example pressing 9 in conjunction with the dialed number. In this case a predetermined Emergency Call Center (ECC) may by automatically connected in parallel line with the destination if the call is successful or, if the call is not successful, the ECC may be exclusively connected for the caller to seek assistance. This feature may additionally include giving an emergency interruption signal or direct interruption by the ECC executive or the calling party, into the destination receiver if the same is busy, applying the ‘barge-in’ technique.

Likewise, another tag number such as 4 may be specified for unsolicited commercial calls, which may be then handled as per the rules set by the subscriber in association with the telecom exchange. For example, all calls added with the tag number 4 may be processed by the receiving party's switch in response to a program codes whereby the call may be diverted to a voice mailbox or may be notified to the destination telephone instrument with the urgency code. If the destination telephone instrument is a modern digital instrument e.g. a mobile cell-phone, it can be programmed to identify the urgency code and process the call accordingly e.g. with a less intense alarm such as only with a beep. Additionally or alternatively, the phone has a display panel such as those used for caller line identification (CLI). The urgency tags communicated with the CLI in analogue or digital form can be simply displayed as such i.e. a suffix with the caller number e.g. 5678902 or 5678901 as per the above example, whereupon the called party is able to perceive the call as urgent or ordinary respectively. In another embodiment, the program logic memory in the phone can be effectively utilized to identify urgency tag numbers e.g. 1 and 2 and show text message e.g. Urgent or Ordinary Call from, with the CLI as shown at 160 and 170 respectively. Number only caller ID is called Single Data Message Format (SDMF), which provides the caller's telephone number, the date and time of the call. Name and number caller ID is called Multiple Data Message Format (MDMF), which in addition to the information provided by SDMF format, can also provide the directory listed name for the particular number. These capabilities in the modern telephony can be effectively utilized to display urgency code numbers alone or the text messages as well, as explained. DTMF signaling for example can be effectively utilized to transmit the urgency number data.

Legitimate application of these tag numbers may be enforced by contractual requirements of various subscribers, or may become a social norm of good etiquette by public education, or may be enforced by rule of law legislated for this purpose.

All calls without any tag number may be handled as a call with a specific low urgency tag or in the usual manner. In another variation there may be only one specified number e.g. 0 to be added to tag the call as Urgent, which may be processed accordingly, and rest of the calls without any tag will be handled as usual.

As per FIG. 2, the receiver's phone can also be enabled to distinguish between the calls with different tag numbers and is programmable to handle these differently depending on the user selection. In the example 210, the instrument has keys 203 (default) and 204, to allow all or redirect ordinary call to a voice mail service if available, respectively. The instrument is programmed to show the status of incoming call settings as above, by way of a novel traffic lights graphics display panel, applying various embedded programming techniques. For example, in default situation or on pressing 203, the display may show “Receive All’ with a green traffic light position (220). On this setting, all calls are allowed completion but different calls with different tag numbers are received with different alarm features as disclosed herein. Likewise, on pressing 204 the instrument displays Urgent Calls Only (230) corresponding to yellow light position. On this setting, calls with urgency tag numbers signifying high urgency are completed and those with ordinary urgency are blocked or diverted as per a different protocol as set forth by the user. The highest level of privacy is programmed if both 203 and 204 are pressed, in which case the graphic panel will display ‘No Incoming’ status and a corresponding red traffic light display (240). On this setting all calls are barred. In one embodiment, the subscriber can have the option of allowing only emergency calls attached with a particular tag such as 9, at the highest level of urgency corresponding to the red light, then the display will read ‘Emergency Calls only’. In another embodiment, another level of privacy denoted by e.g. blinking red light can be set, in which case the graphic will display ‘Emergency Calls Only’ and the red light (240) blinking. Likewise, in the said green position, the program may or may not allow commercial call, or alternatively a different level of privacy can be provided in which only commercial calls with a specific tag number e.g. 4 may be disallowed, corresponding to a display reading ‘All Calls Except Commercial’ and blinking green traffic light (220). These controls can be exercised at the called party switch, in response to each of these profile setting in the switch program, entered through an automated interactive process or by operators, enabling the switch to handle the call according to a protocol. For example, if the profile is set Urgent only at the exchange program, in response the called party keying in specific numbers activating the said profile, an ordinary call to the called party received at the switch will be blocked or diverted to a Voice Mail Service (VMS), of another number specified by the called party for example, by keying in the said number in response to the said interactive process or through the operator. There can be a facility to provide the above options through an Internet application program, enabled to make necessary changes directly in the telecom serves, or through operators. Alternatively, the phone itself is capable of blocking or diverting the call to an internal voice mailbox or to a number pre-set by the subscriber, as per a menu driven program of setting privacy profiles. Though special keys have been shown for a non-limiting example, the features can be activated in various ways without special keys and by using prior art instruments e.g. purely menu driven activated by a new program feature, or an interactive voice response system working autonomously with recorded instructions, or human telephone operator assisted, or Internet enabled etc.

In another example embodiment, the profile can be set by dialing a particular number e.g. 1231 for green, 1232 for yellow, and 1233 for red type of setting as above. Such setting through dialing the said numbers can trigger a change in the profile setting in the embedded operating system of the phone. Alternatively, dialing can be directed to the switch program, with or without an interactive voice response system to assist the subscriber in setting a profile as per this invention. In this case, a limited version of these features can be also availed through the phones that do not have in build programming capability. For example, if 1232 is dialed, the switch program can register a change by which ‘Urgent only’ type of setting is activated at the switch whereby ordinary calls are blocked or diverted at the switch level.

In one embodiment, different levels of settings as disclosed above may be interlinked to and automatically set upon selection of one of the profile as per another program e.g. the profile option in the cell-phones generally available. In this case, an incoming call is processed as per the said profile in the said other program, and as per the present disclosures. For example, on selecting ‘silent’ mode, the privacy level corresponding to ‘Urgent only’ setting corresponding to yellow light as above will be set, and the calls will be then processed accordingly as disclose above, with further modification that the buzzer will remain silent or just give a single beep as programmed in the said other profile. As a result, in silent or meeting mode, the phone will complete calls only with a high urgency tag e.g. 2 or 9 and block or transfer the calls with low urgency tag e.g. 1, with the difference that the said calls with high urgency tags will be notified at the phone silently e.g. with vibration and emission of light, and with a beep optionally as programmed. However, by default or when General profile is activated, privacy level is set at green traffic light and when Meeting profile is activated, privacy level is set at red level. This can be achieved by embedded programming in the phone memory, which applies a table with instructions on which privacy level is to be set upon which profile selection.

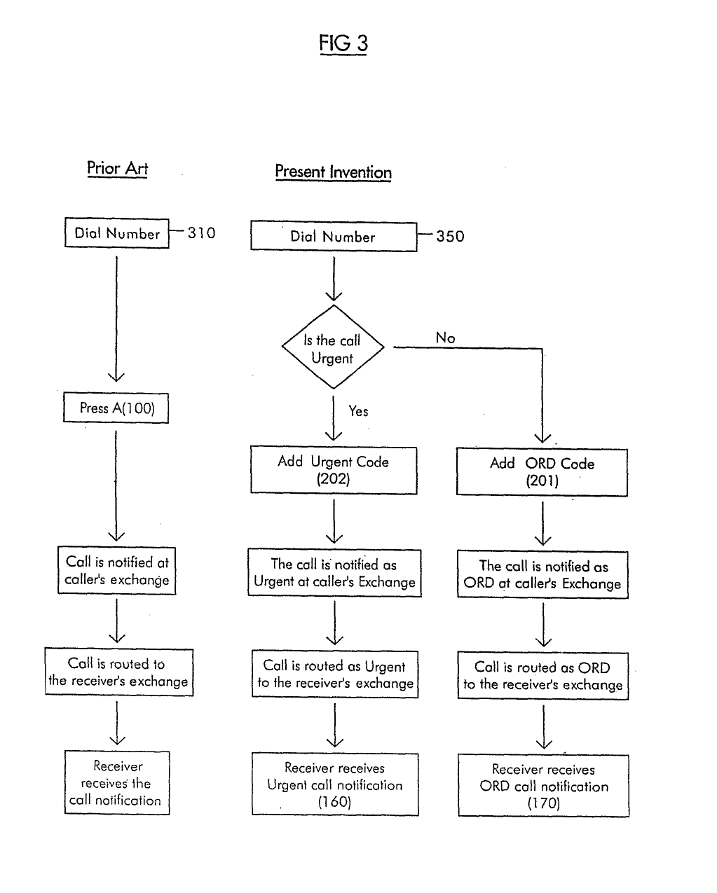

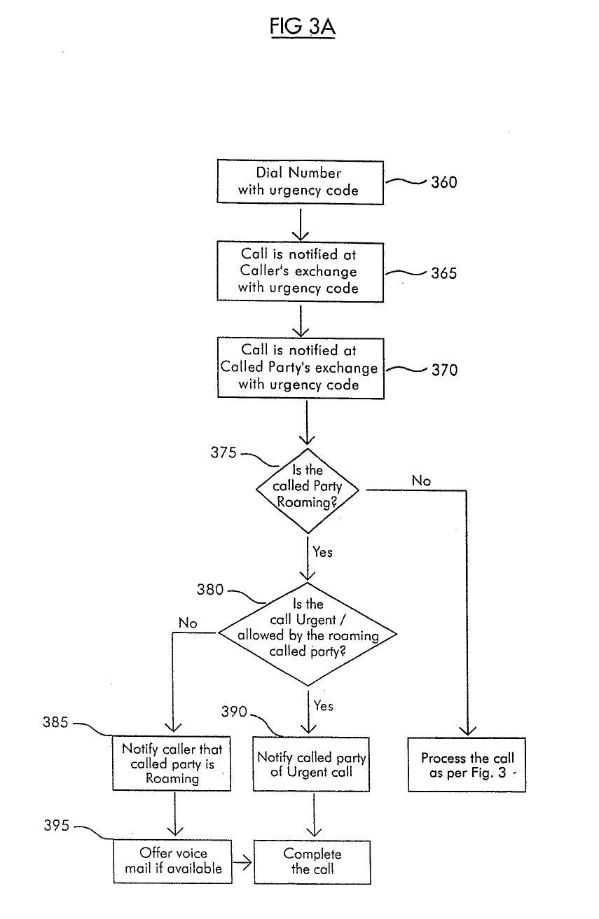

FIG. 3 shows flowcharts of a prior art telephone call vis-à-vis the present invention. The subscriber dials a number at 310 and presses button A of a mobile handset as shown in FIG. 1. The call is notified to the calling party's switch and routed to the receiving party's switch, using telecommunication techniques. In the present invention, at the time of dialing the number at 350, a decision is made by the caller as to whether the call is to be processed as Urgent or not. As a result, a tag number is added to the dialed number, as described earlier. This results into the receiver finally getting a notification of an Urgent (160) or Ordinary (170) call. This process can be readily achieved by various programming techniques.

FIG. 3A shows a non-limiting embodiment of present invention when the called party is a mobile telephone user and is Roaming out of his subscribed geographical area. For example, the called party is a subscriber in India who is presently in USA, in a Roaming mode. In this case, all the calls at present made to the called party from India or any third country will be first notified at the called party's Indian exchange and then routed to the present location of the roaming called party in the USA, through a complex inter-service network. As a result, the charges for receiving such calls while roaming are several times higher than normal local calls. Now if suppose a caller in India makes a non-urgent call like a commercial call and received by the roaming party in USA, it leads to a lot of irritation and waste of money. However, the calling party had no intention of bothering the roaming called party if it new that she/he was roaming. The present invention effectively tackles the problem by handling such non-urgent calls differently if she called party is roaming and has specified a rule pursuant to services offered by his/her exchange.

Referring to FIG. 3A, at 360 the calling party dials the number of called party with an added urgency tag number such as 1,2, 9 or 4 as explained earlier. The call with the tag is processed via caller's exchange switch at 365 and is notified at called party's exchange switch at 370. At this stage, there can be an option of the program feature posting the call at a higher tariff applicable on urgent calls, at the billing processor of the calling party and the billing processor of called party, at 365 and 370 respectively. At 375, applying computer program logic, a decision is made at the called party's exchange whether the called party is Roaming out of his/her subscribed geographical area. Accordingly, if the called party is actually roaming and has opted for any rule specifying that calls with only highest urgency tag numbers such as 2 or 9 be connected in the roaming mode and the rest be diverted to VMS, the call is handled as such. Thus, at 380 the decision is made applying computer logic that if the call has high urgency tag numbers such as 2 or 9, notifying the called party at 390 completes it, even if the called party is Roaming out of an area. However if the call has a low urgency tag such as 1, applying computer program logic the caller is notified by the means of playing a distinct audio and offering VMS if available. Additionally, at the telecom exchange level the computer logic may be programmed that all commercial calls such as those tagged with the tag number 4 are never forwarded while the called party is in Roaming mode, as a service feature. However, if the telecom service does not have these features but instead handles calls as per FIG. 3 explained earlier, the subscriber could still detect low priority calls when received with distinctive features and decide not to take the call. For example, if a caller line identification panel is called party's phone displays a suffix of 4; she/he will know that it was a commercial call. In the prior art sometimes if the call is diverted to a VMS after being routed to the roaming subscriber, the call has to be again routed back all the way to the called party's exchange switch, leading to much higher cost due to what is generally referred to as Tromboning effect. The technique explained in FIG. 3A is more effective in handling the calls as per urgency tags, while the called party is roaming. If at 375 the computer program logic detects that the called party is not roaming, the call is completed as usual or processed as explained in FIG. 3 earlier.

Further, the geographical area of roaming where a particular type of call will be debarred may be selected by the called party subscriber, pursuant to service features of the called party's telecom service provider, depending on pricing or other convenience factor perceived by the subscriber. For example, if the pricing of calls for roaming within all states of India is the same, one may opt that the low priority calls such as 1 be barred only if roaming out of country e.g. while in USA. However, despite the same cost of calls while roaming within India, one may perceive that he or she still would not like to be disturbed with low priority calls while away from the subscribed area, say while on a holiday to another district, and so opt for yellow level of privacy.

Exception rules can be defined by a called party by specifying numbers, which are to be processed in a particular way, irrespective of the urgency tag supplied by the caller and/or irrespective of the privacy setting of the called party. For example, one may enter the number of his boss or wife to be always treated as an urgent call corresponding to the urgency TAG 2 and/or the same to be completed irrespective of the urgency code supplied and the privacy setting. For example, even if the highest level of privacy corresponding to red traffic light has been selected in which all other calls are shut and/or even if an urgency TAG 1 has been supplied, the exception rule set in the program can compulsorily notify a call e.g. from boss or wife with a high urgency code such as 2 or 9. In one embodiment, the called party A may opt for a setting by which all calls are transferred to another party B e.g. when A has set the highest privacy mode corresponding to red traffic light as explained above. An important limitation in such a situation could be that even B can't call A, because of the call transfer setting, which applies globally. The present invention contemplates that to overcome this shortcoming, the switch of called party is programmed to first make a determination if the call is originating from B's number supplied by A in an exception list e.g. through menu driven program setting option in his phone. To implement this, referring to FIG. 3A, a determination is made at 385 if the call is from B and if yes it is completed but if it is not, it is transferred to B at 395, instead of the voice mail as shown. This can be presented as a hotline service whereby A may choose certain ‘hotline’ numbers for example that of B, the calls to and from which will always be completed as Urgent. These can be achieved by programming techniques applied at the switch and/or at the operating system embedded in the telephone instruments.

Further programming feature can be such as to enable calls to and/or from particular telephone numbers with a particular urgency tag always. For example, a call to and from emergency numbers such as 100 or 911 may be always completed with an emergency priority tag number, irrespective of whether or not the caller has added the same tag. Likewise, a call originating from an identified commercial caller e.g. a telemarketing subscriber can be always added with a commercial priority tag number e.g. 4, as per rules set in the program embedded in a instrument or at the switch.

The privacy profile can be pre-programmed or set automatically according to local time, for allowing calls with specified priority tags during a time and disallowing other calls. For example, the telecom instrument itself or via it the exchange switch program may be set to allow low priority calls such as commercial calls with tag number 4 only during a particular hour say 1 to 2 PM. Similarly, only high priority calls such as Urgent calls with TAG 1 and/or Emergency calls with TAG 9 only may be allowed during late night to early morning e.g. from 1 PM to 8 AM local time at the called party phone or at the receiving switch. This can be programmed through a menu driven option in the program embedded in the phone by which the phone is set to automatically switch to the second or third level of privacy corresponding to yellow and red traffic lights respectively, as explained earlier. Alternatively, the feature can be offered by a telecom service provided who can set the rule at switch program, on being requested by the subscriber, to set the desired level of privacy according to local time, as explained. This feature can effectively handle a situation where a caller from a different time zone is inadvertently making a low priority call without realizing that in the called party's time zone is inconvenient, e.g. when the called party is roaming in a different continent. This will be very advantageous in a fast globalising environment in which such mistakes increasingly become probable.

The tagging of calls based on urgency, by adding a digit tag in addition to the dialed number of call filtration/restriction rules as above may be achieved by program embedded in digital telephone instruments, interacting with telecom exchange switch programming that notifies the said added urgency tag number to a receiver instrument, which is then processed by the program embedded in the instrument, in response to the rules set by the receiving party. The notification of the additional tag number can be achieved by various techniques such as those used in ‘direct inward dialing’ (DID) in a modern telecom network, whereby the added tag numbers 1, 2, 4 or 9 can be transmitted to the receiving party by its exchange and the same is processed by the receiving party's telephone instrument, pursuant to the programming at the receiving party's telephone apparatus. For example, in a Signaling System 7 (SS7) telecom network, the Service Control. Point (SCP) can be stored with a database about how numbers with each urgency tags will be handled.

In another example embodiment, a called party mobile phone will have programming features, to filter calls when one is roaming out of a service area. For example, a rule may be set that calls having low priority tag number such as 1 or no priority tag numbers may be blocked if the mobile subscriber is in roaming mode, outside his local area network. This feature can be activated at the switch by programming or at the mobile handset, which has the program capability in its embedded operating system. In one embodiment, an additional feature can be that whenever a call is blocked, a stored audio or SMS message may be transmitted to the caller, informing the fact that the called party is roaming and the call is inconvenient. A telephone receiver utilized advantageously as per these disclosures can have embedded program features for activating a different set of alarm features like caller line identification display, graphic display, ring-tone, buzzer, hooter and/or vibration, depending on different urgency tag numbers notified by the switch as explained. For example, the program embedded in the telephone receiver, on identifying a low urgency tag number e.g. 1 can enable display of the caller number with a suffix 1 and/or with prefix ‘Ordinary Call from’, as shown at 170 in FIG. 1. The embedded program feature can also activate a particular ring-tone preferably a low intensity ring-tone for such an ordinary call. However, if a high urgency tag number such as 2 or 9 is notified, the display can read with appropriate suffix and/or prefix e.g. 2 and or ‘Urgent’ (160), respectively. At this time, the embedded program can activate emission of a light preferably an intense light e.g. red light, playing a particular ring-tone preferable on intense ring-tone such as a hooter type tone and an intense vibration. These features can be provided by effectively utilizing the software and hardware resources of a digital telephone instrument in particular a cell-phone instrument, by a person skilled in the art. Further program features like automatically transferring such an urgent call as per pre defined protocol, if it is not completed with a specified time limit e.g. 60 seconds, can be effectively provided.

The call filtration/restriction rules as above can be topically programmed for a single incident only or as a standing instruction for indefinite periods. For example, a subscriber may have to set a profile rule each time e.g. the second level of privacy corresponding to yellow traffic light every time he or she is roaming or in the night time. Alternatively, an ongoing rule may be set up that only urgent call be allowed in while roaming or in the night time. The ongoing rule may be set up by the subscriber through his handset by pushing specified buttons which may lead to the telephone instrument itself being programmed to filter the calls as desired, and/or it may lead to programming at the switch level, to accordingly handle incoming calls to that telephone number. Alternatively or additionally, the exchange may offer some of these filtering services enabled as a part of service feature, e.g. filtering call while roaming and/or night time, which may be deselected by the subscriber if so desired, by pressing specific buttons or via an operator or through an interactive voice response system. It is contemplated that based on demand, usage and utility of these services, automatic filtration logics operable at the exchange level and at the level programming embedded in the telephone instrument can be developed.

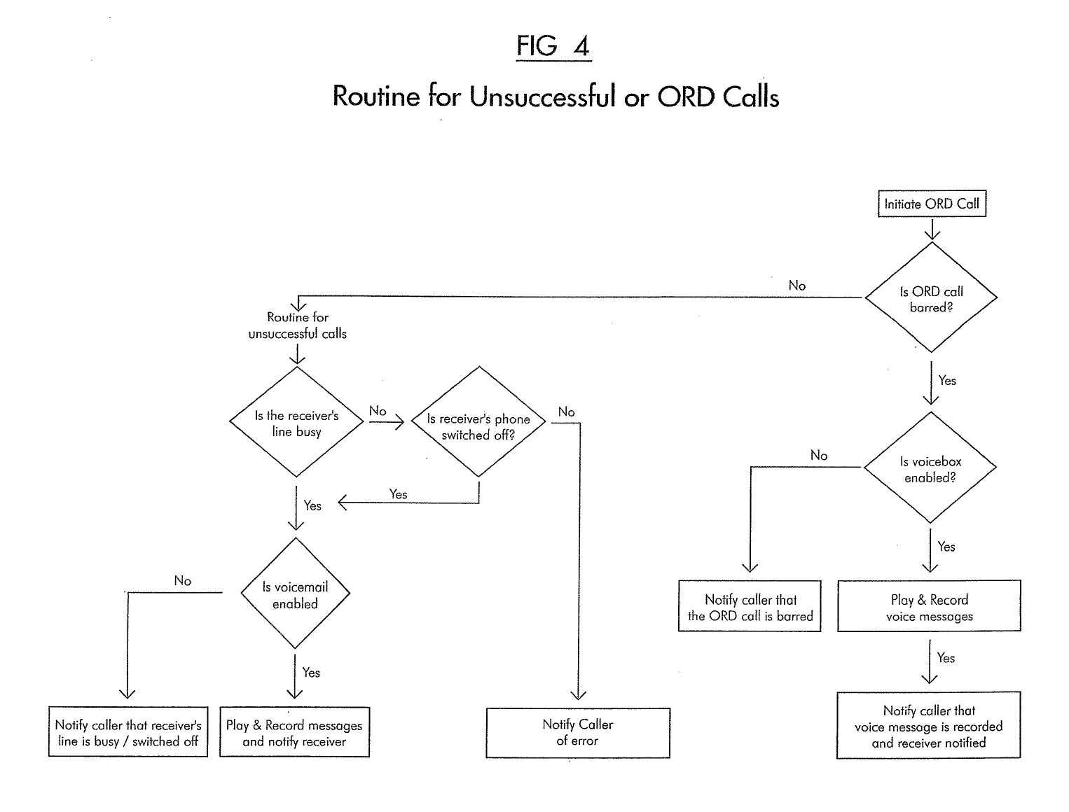

FIG. 4 shows flowcharts of handling of unsuccessful Ordinary calls with low urgency tag such as 1 or 4. In this case first a decision is made whether Ordinary and/or Commercial calls have been barred by the receiver in which case a VMS service may be activated. In another embodiment, the caller may be given an option through an interactive voice prompt, to change the urgency code if desirable. If the call is not barred but yet unsuccessful is handled as per a typical routine for usual routing of unsuccessful calls whereby in the event of called party's line being busy or switched off, and if VMS is enabled, a pre-recorded message is played and additionally a recorded messaging facility may be offered. If the call could not be completed for any other reason such as congestion, an error message may be accordingly communicated to the caller. In the event of the called party's line being busy or the ordinary route being busy, the program may again offer a choice to the caller to upgrade the urgency level if desirable, through a interactive voice prompt.

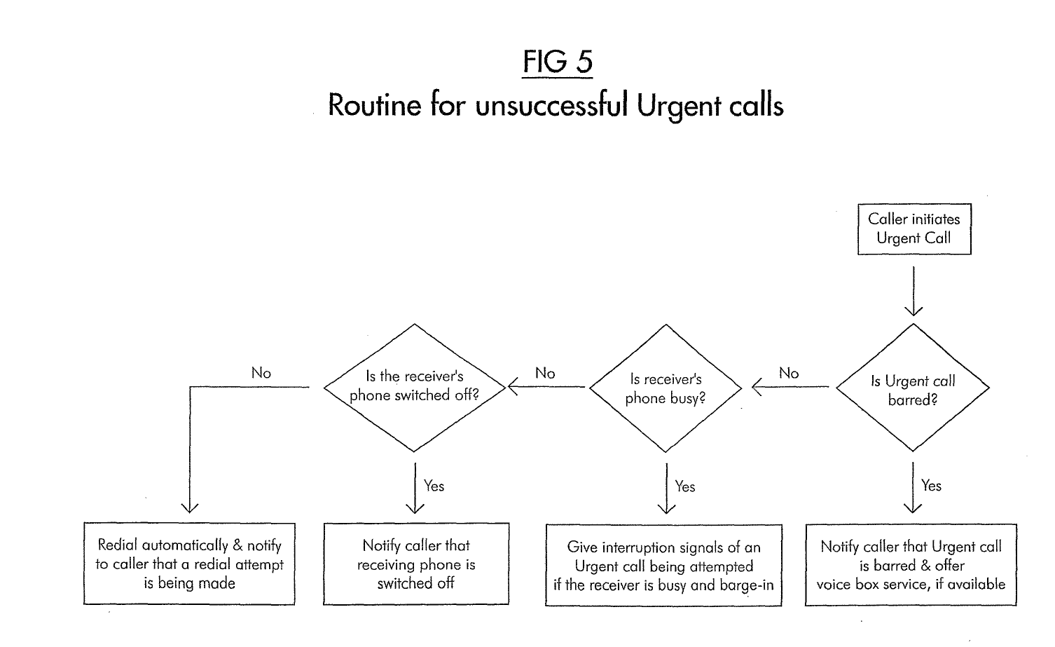

FIG. 5 shows a flowchart for handling an unsuccessful Urgent call that may include automatic redialing and/or interruption signals such as an intense call-waiting audio and ‘barge-in’ feature if desired, as described. The caller may be first asked to upgrade the call to emergency level by keying in e.g. on a voice prompt. In this case if upgraded the call may be completed by barging in, which may be preceded by an interactive voice prompt to ask permission to barge-in.

In one of the embodiments there can features like routing the Emergency and/or Urgent calls through a different priority route reserved for such calls or any other route that may be available, including a long distance route, if the usual route is busy. In another embodiment, a preferential right of way may be provided whereby if the route is busy while an emergency call is being attempted, a network feature can detect an ordinary call engaging the said route and drop it i.e. disconnect it to make way for the emergency call. This can be done utilizing programming at calling party's switch and in the network, whereby after determining that the usual routing for an emergency and/or urgent call is busy, a predefined alternative route or a route from a set of predefined alternative routes such as long distance routes available to the destination number is activated. Urgent calls esp. such calls diverted through longer routes can be charged at a higher rate, by way of called party switch processor sending an electronic instruction to its billing processor. Likewise, if desirable, a called party could be also charged for the service by way of a flat levy or by a differential charge for urgent calls, triggered in the same way, i.e. the called party switch program activating the billing processor.

In one of the embodiments, alteration in profile rules and call filtration can be based on geographical coordinates of the mobile phone, in a Location Based Service (LBS). A number of alternative positioning technologies, including AOA (angle of arrival). Cell-ID, E-OTD (enhanced observed time difference), GPS (global positioning system), A-GPS (assisted GPS), D-GPS (differential GPS), signal attenuation and TDOA (time difference of arrival) etc. may be utilized to identify the location of a mobile phone and then autonomously change rule based profile of the user, applying programming techniques. Such alteration in profile rules and call filtration may result into one of the profile being automatically selected on entering a defense establishment. In another embodiment, the phone will be automatically switched off on entering a particular area e.g. an airfield. For example, it may be programmed that when a wireless mobile phone is in a particular cell or a group of cells, specified restrictions are automatically enabled. For example, a university professor may set a rule for receiving urgent calls only while in the cells covering his university campus, while allowing all calls except commercial while in the cell covering her home. Exception rules can be set advantageously e.g. in case of a high security prison or a theater whereby all cell-phones are autonomously switched to the highest level of urgency protocol corresponding to red traffic light setting as explained, as a network feature. Exception rules can provide for specific phone numbers, say of jailors or staff, through programming. This will be more advantageous than conventional jamming techniques. Device independent TAPI (Telephony Application Program Interface) based techniques applied in geographical tracking with modem/ISDN can be modified and applied to implement the disclosed features. These methods of geographically positioning and location a mobile phones are expensive and have lower accuracy and lower resolution area. Therefore, simpler methods are advantageously utilized in detecting, communicating and controlling the profile settings of mobile phones.

In another example, a person may set rules through pushing specified buttons on his mobile phone, allowing only urgent calls while driving or commuting. This feature can be automatically enabled by the called party's switch by programming that a database log of cell-phones commuting from one cell to another within a specified time in the recent past e.g. up to 10 seconds back at any time is maintained. On receiving an ordinary call a determination is made if the called party's number is in this data base and if yes, the call is blocked or diverted as per the second level of privacy protocol corresponding to yellow traffic light, even if no privacy level or a lower privacy level such as green traffic light has been set by the commuting subscriber.

In another embodiment, the profile can be altered on the basis of proximity to a secondary wireless transmitter and receiver or transceiver device provided for this purpose. For example, a program code transmitted to mobile phone through a radio transmitter can trigger a change in the profile setting of a cell phone user to a high level of privacy protocol e.g. corresponding to the red traffic light.

This way, whenever the user enters a particular location, specified restrictions are automatically enabled—e.g. Emergency calls only in a Medical facility or while sitting on a Driving seat. If these are to be activated instantly on a mobile phone being taken along in a particular facility where restriction apply, the required programming signals can be automatically transmitted to the telephone via infrared, blue-tooth or other wireless radio communication techniques. The restricted area can be physically defined and restriction applied for example by way of placing such transmission equipments at the entrance. In one embodiment the secondary wireless device can be a wireless instrument programmed to have the capability of changing profiles of other mobile phones placed in a close range, by transmitting it the required instructions to change the profile rule. Signals so transmitted then may activate the required rule settings by embedded system in the telephone instrument or transmitted onwards to the switch of the local exchange to in turn process the incoming calls as desired. Likewise, in an embodiment the desired change said profile could be to ‘Switch-off’ the mobile phone autonomously as explained, e.g. on entering an airfield or an aircraft. These program features can be either at the exchange level or within the embedded systems in advanced telephone instruments. Further, the exchange program features and the program features of such telephones can autonomously interact with each other to apply the desired settings. For example, the paging capability of a mobile cell phone can be utilized to send and receive message codes programmed to interact with the operating system of the telephone to alter the profile as desired. Additionally, a profile altered as above may be reinstated on exit, by keeping a database of numbers and their original profiles before alteration, and transmission of codes to reverse the alteration restore the original profile. For example, if the phone was switched off autonomously as explained above as a result of the user entering a controlled area, the same will be again switched-on on the user exiting the said area.

Utilizing a secondary radio transmission and receiver or a transceiver device to detect and interact with a mobile phone in the close vicinity, the precision also known as granulation of tracking can be improved to cater the requirement of altering profiles only if the user is within a small restricted area such as an office. In an example embodiment, electronic codes may be transmitted to the mobile phone using the secondary radio device installed in a restricted area and those codes may be forwarded onward to the exchange, which may trigger a change in the profile rule of the called party in response to the exchange program features. In another variation, the said codes may trigger a change in the profile rule in the operating system embedded in the phone, in response to the program features in the operating system. In another embodiment, the message forwarded to the exchange may trigger transmission of program codes to the mobile telephone instrument, which may in turn change the profile rule in the operating system embedded therein. The transmission and receiving of said codes can be done employing various techniques including MMS and SMS. Near Field Communication (NFC) technique by which loosely coupled inductive circuits share data over small distances, generally operating within a frequency range of 13.56 MHz may be effectively utilized. If the restricted area is large enough to be defined by a call transceiver, the Cell of Origin (COO) or Cell ID or the nearest tower report data can trigger the chain reaction to change the profile rule as desired, as explained above. In one example, exclusive towers may be erected to serve a highly secured facility and profile rule of any mobile phone being served by such tower i.e. within that facility can be controlled. Geo-fencing techniques may be applied to start tracking a mobile phone only in a predefined geographical area and then control the profile of the user as per rules for that area. These features may be effectively provided on an Internet server and as an eCommerce application. Further, exception rules may be applied using autonomous control of certain numbers in certain ways as per pre-identified database of numbers with a table or rules to be applied to each. For example, in a prison complex it may be desirable to allow all calls to and from specified security personnel only. A database of the mobile phone numbers of these personnel may be stored in the device controlling the autonomous change of profiles as discussed above, with a rule that the profile of such personnel will not be changed or will be changed in a certain way, while the rest of the phones will be fully blocked. In a SS7 telecom network, the Service Control Point (SCP) can be stored with a database about how phones in a particular positioning range will be handled and exception rules if any.

As there is more and more adoption of common standard as telephony advances globally, these features can be standardized into protocols and adopted by various operators. These standards may demand homogeneity for example all mobile phones being infrared or blue tooth or GORS enabled for simplest implementation of above features. Practical implementation of these features may lead to new rules like only such mobile phones which are enabled for tracking and changing of profile may be allowed in a facility e.g. in an auditorium while the rest will have to be deposited at the gate. Regulatory pressures and convenience factors are likely to more and more precision in operators' ability to position mobile phones. The disclosures here can be applied effectively on an Internet eCommerce site offering services to mobile users as well as facilities which would like to control the profiles of mobile phone users entering their premises. For example establishments like cinema halls, autitoria, churches, offices etc. can opt for geo-fencing through such eCommerce website, by demarcating their coordinates by a method disclosed, and selecting rules to be applied e.g. to a high privacy level corresponding to red traffic light as per these disclosures.

According to the foregoing, it is evident that disclosed herein is a method for tagging and processing telephone calls with an urgency tag number supplied by the calling party, comprising the steps of dialing a called party numbers and dialing at least an additional urgency tag number, notifying the calling party's switch the said called party number and the said urgency tag number and forwarding both to the called party's switch, receiving the said number and the said urgency tag number at the called party's switch, processing the call on the basis of a profile rule set by the called party in respect of the said urgency tag number, applying computer program logic. The method includes activating at least one of the alarm features of said called party's telephone instrument, including alphanumeric or digital graphic display of caller line identification, ring-tone, light emission and vibration to operate differently in response to a different urgency tag number, applying computer program means. It further includes activating charge of different tariffs for the said calls with different urgency tag numbers, at the billing processors of said caller and/or the said called party, applying computer program means. The said urgency tag number may consist of at least one digit from the serial numbers 1 to 9 or 0. A plurality of urgency levels may be denoted by a plurality of tag numbers. For example, 1 signals an ordinary call, 2 signals an urgent call, 9 signals an emergency call and 4 signals a commercial call. The said urgency tag numbers can be added by dialing the said number key in a telephone dial or by dialing a special keys (201, 202) provided in a telephone dial, for each of the said urgency tag numbers.

Call with a high urgency signaled as per urgency tag numbers 2 and/or 9 in the above example can be routed through a priority route other than the regular route, including long distance routes, if the regular route is congested, applying computer program means. An urgency tag number could be added autonomously, to calls dialed from a specific telephone number or dialer without any urgency tag number, applying programming. Called party can set profile rules consist of levels of privacy programmable by the called party, levels determining how each of the said calls with said urgency tag number is to be processed. The processing consists of allowing completion of a call with a first set of tag numbers e.g. 2 and/or 9 and disallowing a call by blocking or diverting the call with a second set of tag numbers e.g. 1. In one embodiment, different alarm features in the said called party's phone are activated e.g. different ring-tone, emission of different colors of light, different vibration etc., in response to the calls that are allowed as above. The blocked calls may be diverted to a recorded voice message or to an interactive voice response or to a voice mailbox or to another specified telephone number. The treatment of such blocked calls can also be programmed to be as per different tag numbers from the second set, e.g. it can be programmed that the ordinary calls with TAG 1 are diverted to a voice mailbox whereas the commercial calls are diverted to a recorded voice message which just announces to the caller that the called party is not interested in any unsolicited commercial call. In another embodiment the commercial call can be taken to a different voice mailbox. In another example, the treatment of blocked call can include transferring the call to another specified number. For example, a busy executive may opt that all emergency and urgent calls be diverted to his secretary if the privacy level at the time does not allow completion of the call. This can be implemented in the embedded system by programming a menu driven algorithm.

Various privacy levels can be programmed through a graphic user interface (GUI) attached to the called party's phone displaying three levels of choices designated by a traffic light graphics for example, a first level (220) corresponding to green light, signifying lowest privacy, when all calls are processed for completion, activated by pressing specified button (203), a second level (230) corresponding to yellow light, signifying medium privacy, when calls with a tag number from the said first set corresponding to a high urgency only are processed for completion and calls with a tag number from the said second set signifying low urgency are processed for being blocked or diverted autonomously, activated by pressing specified button (204), and a third level (240) corresponding to red light, signifying highest privacy, when no calls or only calls with a tag number from a third set corresponding to emergency calls are processed for completion and all calls or all other calls are processed for being blocked or diverted autonomously, activated by pressing specified key (203 & 204). In another embodiment, the said first level further consists of another level corresponding to the said green light blinking, when all calls except commercial calls identified by a specified urgency tag number are disallowed, and/or the said third level further consists of another level corresponding to the said red light blinking when all calls except emergency calls identified by a specific urgency tag number are processed for completion, whereas in the said third level no calls are processed for completion. There can be a programmable feature for applying exception rules in the said program. The feature when activated prompts the called party for keying in a telephone number for storing, on which the said exception rule is to be applied and also keying in an exception urgency tag number that will be always applied on a call from the said number irrespective of a notified urgency tag number that may have been added by the caller. Whenever a call is notified from the said stored number, the call is processed as per the said exception rule wherein the notified tag is replaced by the program by the exception tag number stored, by program. For example, one may set that a call from his wife or boss will be always treated as if with an urgency code 2 or 9, by entering their number and the tag code, ion response to menu driven options. When a call is notified from the said number, the call is processed as per the exception rule set, irrespective of the tag notified with the number. As per the above example, if wife or boss calls with an urgency code 1 supplied by their switch because she or he did not add any urgency code, the same will be processed as if it carries an urgency code 2 or 9, as entered in the exception rule memory. Likewise, one may enter a number of a nagging seller who has the habit of making unsolicited calls disguised with high urgency codes, with a rule that it will be always treated as if having TAG 4 applicable on commercial callers. Then the imbedded program processes the call accordingly, by completing or blocking or diverting as per the said exception rules. This can be achieved by embedded programming techniques whereby a menu driven choice can be offered to the subscriber to set exception rules. In another embodiment, the said profile at the said second level is set autonomously, if the called number is a wireless mobile number and the called party is within or without a specified cell or a range of cells.

The privacy profile of a called party can be also activated automatically in certain circumstances. For example, the profile can be set automatically at the second level corresponding to yellow light, if the called number is a wireless mobile number and the called party has been in motion from one cell to another, within a specified period of time before the time call is being processed, signifying the called party is traveling. The profile can also be set at the said second level autonomously, if the called number is a wireless mobile number and the called party is roaming out of a specified service area, avoiding inconvenience and unnecessary cost. The profile rule of all phones in a time zone could be set autonomously on the basis of the local time at the receiving switch. If the receiving apparatus of the called party is a mobile phone and a profile rule is set autonomously on the said phone being located within or beyond a range of geographical co-ordinates. This can be achieved by determining the said location by proximity to a control point consisting of an electronic transceiver capable of sensing the presence of a cell phone within a range, communicating electronic codes to the said cell phone crossing through the said control points and applying said codes for altering a profile setting of the said mobile phone autonomously. In one embodiment, the said altering can be switching off the phone. The said communication may be through short message service (SMS) or multi media service (MMS). An additional feature can be recording the said altering in a database signifying entry into a controlled area and reversing the said alteration, on the said mobile phone crossing another control points or the same control points for a second time, signifying exit. For example, if the phone had been switched off in response to the first alteration, it may be switched on by a second alteration.

The method can also include setting at least one of the said privacy automatically on at least one of the profiles being set in at least another program of profiles. The program capability in the operating system embedded in the modern telecom instrument such as a mobile cell-phone instrument can be effectively utilized for the purpose. For example, in a conventional profile menu found in most of the cell-phone instruments, when a profile is set at General, the program automatically sets the above-mentioned first level of privacy corresponding to green traffic light. Likewise, on setting a Silent profile, the second level corresponding to yellow light and on Meeting third level corresponding to read light is automatically set as programmed in the memory of the instrument.

A telephone instrument can be provided with special keys (201, 202) to add an urgency tag numbers, by providing parallel keys marked with respective text but acting as the corresponding number key, e.g. key 201 meant for ordinary call, keys in the digit 1. A telephone instrument with special alarm features to process calls with different urgency tag numbers has imbedded program to lead the said code and activate accordingly. The said activation can include displaying the calls with different urgency tag numbers in different ways (160, 170) on an alphanumeric of graphic display such as those used for caller line identification. In another example, a call with emergency tag e.g. 9 is identified as such and a hooter ring tone, red light emission and vigorous vibration is activated as per the embedded program utilizing the software and hardware resources. A digital telephone instrument with a graphic user interface mimicking a traffic lights choice system as per FIG. 2, programmable by a user by pressing key (203, 204) to set profiles to process calls with different urgency tags in different ways is effectively utilized to simplify the process. A modern telecom network and related apparatus means including those disclosed herein can be programmed to operate a telecom service as per the present disclosures.

The details of modern telecommunication networks including mobile telephony are well known. These networks depend on digital technology enabled by computers and telecom equipment interconnected through wireless, and fiber optics, etc.

The above processes can be readily implemented through various software and hardware, in a typical modern telecom network. These features can be implemented with similar processes suitably adjusted and codified through analogue and/or digital devices and computer programming languages, to work in different platforms. Although the above descriptions have referred to telephonic voice calls, the same techniques can be applied in respect of other telecommunications applications such as in SMS and Fax transmission and reception.

Although the present invention has been described in detail, various changes, substitutions, and alterations may be readily ascertainable by those skilled in the art and may be made herein without departing from the spirit and scope of the present invention as defined in the following claims. The present invention is not intended to be limited in any way by any statement in the specification that is not otherwise reflected in the appended claims.

Some of the reference marks used in the claims are for intelligibility and do not have any effect on claim limitations.

What is claimed is:

1. A method for making and receiving telephone calls with urgency tag numbers supplied by the calling party, comprising the steps of:
inputting a called party numbers and immediately inputting at least an urgency tag number, by a calling party;
dialing the said numbers, notifying the calling party switch the said called party numbers and the said urgency tag number;
processing the said called party number and the said urgency tag number.

2. The method of claim 1 further comprising:
activating at least one of the differentiated alarm features in the operating of said called party telephone receiver, in response to a said urgency tag number, the said features including at least adding an alphanumeric graphic display (160, 170), a differentiated ring-tone, or a differentiated call-waiting signal, applying hardware and software means, the said called party perceiving the urgency of the said call as per said features.

3. Method of claim 1 further comprising:
activating charge of different tariffs for the said calls with different urgency tag numbers, at the billing processors of said caller and/or the said called party.

4. Method of claim 1 further comprising:
routing a call with a said urgency tag number, the said tag number being associated with a high urgency, through a priority route other than the regular route, the regular route being congested.

5. Method of claim 1 further comprising:
adding an urgency tag number automatically at a service control point.

6. The method of claim 1 further comprising:
The said urgency tag number consisting of at least a digit from the serial numbers 1 to 9 or 0.

7. The method of claim 6 further comprising a plurality of specified urgency tag numbers usable for signifying a plurality of specified corresponding urgency levels, said numbers and said levels consisting of:
1 for an ordinary level
2 for an urgent level
9 for an emergency level
4 for a commercial level
the said urgency tag number being added by dialing or pressing the said number key or a special keys (201, 202) provided, immediately after the called party number.

8. Method as claimed in claim 7 further comprising:
receiving the said urgency tag number at the called party switch and activating at least a differentiated alarm feature in response to a program at the called party switch connecting to the said called party telephone receiver;
displaying a first alphanumeric graphics and/or ringing with a first ring tone, or playing a call-waiting signal with a first audio if the called number is engaged, in response to a call received with the said tag 1,
displaying a second alphanumeric graphics and/or ringing with a second ring tone, or playing a call-waiting signal with a second audio if the called number is engaged, in response to a call received with the said tag 2,
displaying a third alphanumeric graphics and/or ringing with a third ring tone, or playing a call-waiting signal with a third audio if the called number is engaged, in response to a call received with the said tag 9,
displaying a fourth alphanumeric graphics and/or ringing with a fourth ring tone, or playing a call-waiting signal with a forth audio if the called number is engaged, in response to a call received with the said tag 4.

9. Method of claim 8 further comprising:
receiving the said urgency tag number at the called party telephone receiver, the said receiver being a mobile cell phone, in addition to activating alarm features as per claim 8 activating at least emission of light and vibration of a first, second, third types respectively, in response to the said codes being 1, 2, and 9 respectively, suppressing emission of light and vibration in response to the said code being 4, applying embedded programming in the said phone.

10. Method of claim 1 further comprising:
storing and applying a privacy profiles of a called party for the processing the said calls with each of the said urgency tag numbers, in response to called party input, said storing and applying being at a called party switch memory and/or at a called party telephone receiver memory;
said profiles consisting of a plurality of levels of privacy levels selected by the said called party, said selection determining rules for processing each of the said calls with said urgency tag number, said processing consisting completing a call with a first set of tag numbers and blocking or diverting a call with a second set of tag numbers, said completing consisting activating different alarm features as per claim 8 or 9, in response to any urgency tag number being from the said first set, said
diverting consisting connecting to a recorded voice response or to another specified telephone number, in response to an urgency tag number being from the said second set.

11. The process of claim 10 further comprising:
applying exception rules in the said privacy profiles through a menu driven program, the said menu prompting the called party for storing a telephone number on which the said exception rule is to be applied and also for storing an exception urgency tag number to be always applied on a call from the said number irrespective of a notified urgency tag number as per claim 1, receiving a call from the said number with a notified urgency tag, replacing the said notified tag with the said exception tag number, processing the said call as per the said exception tag number.

12. Method as claimed in claim 10 further comprising:
setting the said privacy profile at a said level autonomously, the called number being a wireless mobile number, on the basis of its location within or outside a specified cell or a range of cells.

13. Method as claimed in claim 10 further comprising:
setting the said privacy profile at a said level autonomously on the basis of the local time at the receiving switch.

14. Method of claim 10 further comprising:
setting a said privacy profile at a said level autonomously, in response to the location of the called number, the called number being a wireless mobile number, determining the said location by proximity to a control point consisting of an electronic transceiver capable of sensing the presence of a cell phone within a range, communicating electronic codes to the said phone for applying said codes for altering a profile setting signifying entry into a controlled area and reversing the said alteration, on the said mobile phone being proximate to another control points or the same control points for a second time, signifying exit.

15. The process of claim 14 further comprising:
the said altering being switching off the phone.

16. Method as claimed in claim 10 further comprising:
selecting the said privacy profile rules through a graphic user interface (GUI) attached with the called party's phone displaying three levels of choices designated by a traffic lights graphics consisting:
A first selectable level (220) corresponding to a green light, signifying lowest privacy, when all calls are processed for completion;
a second selectable level (230) corresponding to a yellow light, signifying medium privacy, when calls with a tag number from the said first set are processed for completion and calls with a tag number from the said set are processed for being blocked or diverted autonomously;
a third selectable level (240) corresponding to a red light, signifying highest privacy, when no calls are processed for completion and all calls being blocked or diverted autonomously.

17. The process of claim 16 further comprising:
The said first level further consisting of at least another selectable level corresponding to the said green light blinking, when all calls except calls with a specified urgency tag number are allowed for completion
The said third level further consisting of at least another selectable level corresponding to the said red light blinking when all calls except calls with a specific urgency tag number are blocked or diverted.

18. Method of claim 16 further comprising:
setting the said privacy profile at the said second level autonomously, if the called number is a wireless mobile number and the called party is roaming out of a specified service area, applying program means.

19. Method of claim 16 further comprising:
setting of said privacy profile at the said second level autonomously, the called number being a wireless mobile number and the called party being in motion from one cell to another, within a specified period of time before the time call is being processed, applying program means at the called party switch.

20. Method as claimed in claim 16 further comprising:
setting at least one of the said privacy levels automatically on at least one of the profiles being set in at least another associated program of profiles in the operating system embedded in the said phone,
setting the said first level corresponding to green traffic light, on said profile being set at General; setting the said second level corresponding to yellow traffic light, on said profile being set at Silent; setting the said third level corresponding to red traffic light, on said profile being set at Meeting, automatically
applying profile rules as per the said General, Silent and Meeting profiles as-well-as applying profile rules as per the said first, second and third levels, applying embedded program means.

21. The telephone apparatus with special alarm features to process calls with different urgency tag numbers, as per claim 2, including at least an alphanumeric graphic display panel to display receiving of the said calls in different graphics (160, 170), with related hardware and software means.

22. The telecom apparatus with keys (201, 202, 203, 204) to add an urgency tag numbers as per claim 7 and to set privacy profiles as per claim 10, with related hardware and software means.

23. The digital telecom apparatus with a menu driven graphic user interface, programmable by a user by pressing keys to set profiles to process incoming communication with different urgency tags in different ways, as per a traffic lights configuration of claim 16, with related hardware and software means.

24. The telecom network and related apparatus programmable to operate a telecom service as per preceding claims, with related hardware and software means.
